(19) United States
(12) Patent Application Publication
(10) Pub. No.: US 2017/0169485 A1
(43) Pub. Date: Jun. 15, 2017

(54) METHODS AND APPARATUS FOR SOLICITING DONATIONS TO A CHARITY

(71) Applicant: MasterCard International Incorporated, Purchase, NY (US)

(72) Inventors: Suneel Bhatt, Delhi (IN); Vipul Mehrotra, Delhi (IN); Sharan Bakshiram, Gurgaon (IN)

(21) Appl. No.: 15/371,541

(22) Filed: Dec. 7, 2016

(30) Foreign Application Priority Data
Dec. 10, 2015 (SG) 10201510132U

(51) Int. Cl. G06Q 30/02; G06Q 20/10

(52) U.S. Cl. CPC G06Q 30/0279; G06Q 30/0269; G06Q 30/0255; G06Q 20/10

(57) ABSTRACT

Methods and systems are proposed for identifying a segment of a population of individuals to target in an advertising campaign. A database of payment transactions made by the population of individuals and a database of demographic and/or location data for the corresponding individuals, are used to develop a predictive model for predicting the likelihood that a candidate individual in the population will make a charitable donation. Once the model is developed, the predictive model is used to identify the segment of the population of individuals for whom, according to the model, the likelihood of making a charitable donation is high, and then individuals in that segment of the population are solicited for donations.

### CROSS REFERENCE TO RELATED APPLICATIONS

This application claims the benefit of Singapore Patent Application No. 10201510132U filed Dec. 10, 2015, which is hereby incorporated by reference in its entirety.

### BACKGROUND

The present disclosure relates to methods and systems for identifying individuals who are liable to make a donation to a charitable organization (a “charity”), so that those individuals can be contacted to solicit a donation.

There are many factors which influence whether an individual gives to a charity, and if so how large a donation. One is the financial situation of the individual, and what he or she can afford. Another is the character of the individual, and how generous he or she is.

Even for individuals who have disposable income, and a tendency to donate a proportion of it to a worthwhile cause, different individuals may be more or less likely to make a donation to a given charity. For example, this depends upon the stated objective of the charity. Certain individuals, for example, are more likely to make a donation to a charity helping animals. Other individuals are more likely to make a donation to a charity which assists people with immediate needs (e.g. victims of a natural disaster). Yet further individuals are more likely to donate money to a charity with a less immediate objective, such as one which conducts medical research with the hope of discovering new medical treatments for use many years in the future.

Furthermore, individuals react differently to different advertising campaigns. A first individual may be moved strongly to an advertising campaign using images depicting victims of a natural disaster, while a second individual may be repelled by such images and more strongly moved to make a charitable donation by more positive images, such as images used by an arts charity and depicting a theatrical production which could be paid for by charitable donations.

Many charitable organizations devote a significant proportion of their income to advertising campaigns, and part of this budget will be wasted if it is used to advertise to individuals who are not able or willing to make a donation to anyone, who are not in sympathy with the objectives of the charitable organization, or who are unmoved by the images and sounds used in the advertising campaign. By improving the targeting of the advertising, the revenue of the charities can be improved, to the general benefit of society as a whole.

### BRIEF DESCRIPTION

In general terms, the present disclosure proposes methods and systems for identifying a subset (“segment”) of a population of individuals for a charitable organization to target in an advertising campaign, based on transactional data describing payment transactions made by some or all of the population of individuals and demographic and/or location data relating to the individuals.

Specifically, the disclosure proposes using a database of payment transactions made by the population of individuals and a database of demographic and/or location data for the corresponding individuals, to develop a predictive model for predicting the likelihood that a candidate individual in the population will make a charitable donation, the predictive model being a function of data values describing the history of the payment transactions and/or demographic and/or location data for the candidate individual.

Once the model is developed, the predictive model is used to identify a segment of the population of individuals for whom, according to the model, the likelihood of making a charitable donation is high, and then individuals in that segment of the population are solicited for donations.

The database of payment transactions includes data describing past payment transactions made to a charitable organization. Such transaction data is particularly useful for identifying candidate individuals who have previously made a donation to a charitable organization, and so are more likely to do so in the future. However, a useful predictive model may be developed even in the case of a candidate individual who, according to the payment transaction database, has not made a donation to a charitable organization.

The predictive model may be framed as a decision tree, by which a predictive value may for the candidate individual may be obtained by selecting a path through the decision tree according to the data values describing the history of the payment transactions and demographic and/or location data for the candidate individual.

The term “payment transaction” is used to refer to an automated process in which a payment is made to an entity, such as using a payment card. The term “payment card” refers to any suitable cashless payment device, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, transponder devices, NFC-enabled devices, and/or computers.

The term “charitable organization” (charity) is used to mean an organization which has as its primary objective a non-profit activity. In some countries charitable organizations are granted a specific legal status, and if so the definition of the term charitable organization in such countries may be depend at least partly upon this legal status.

### BRIEF DESCRIPTION OF THE DRAWINGS

Embodiments of the disclosure will now be described for the sake of non-limiting example only, with reference to the following drawings in which:

FIG. 1 illustrates a computer system according to an embodiment of the disclosure;

FIG. 2 is a block diagram illustrating a technical architecture of the computer system according to an embodiment of the disclosure;

FIG. 3 is a flow diagram illustrating process steps which are performed by the computer system of FIG. 1 during a method of generating the predictive model;

FIG. 4 is a diagram illustrating a possible form of the predictive model;

FIG. 5 shows a method for using the predictive model of FIG. 4 to perform targeted advertising; and

FIG. 6 shows a sequence of sub-steps which may be used to perform one step of the method of FIG. 5.

### DETAILED DESCRIPTION

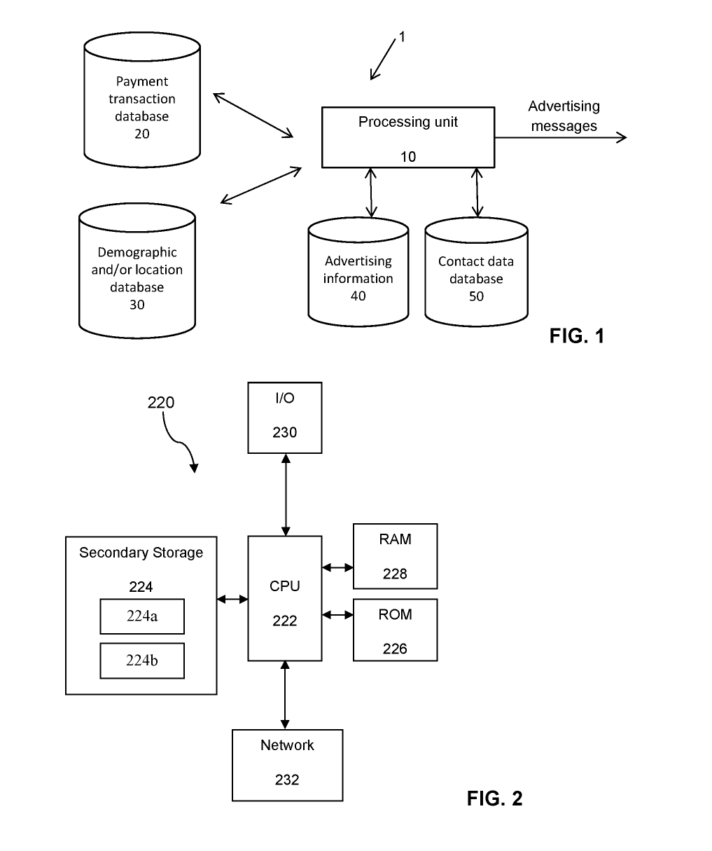

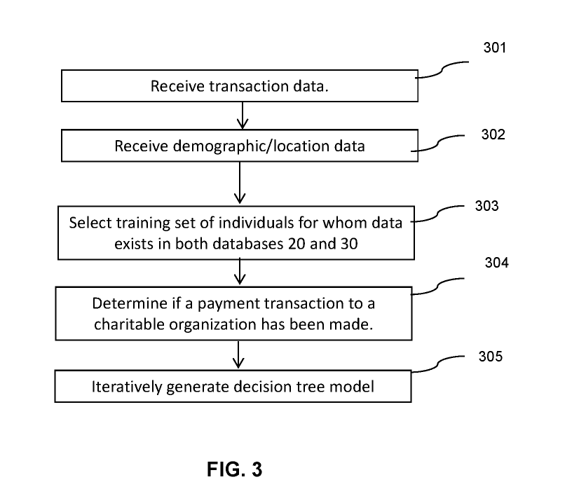

FIG. 1 illustrates a schematically a computer system 1 which is an embodiment of the method, for performing a method according to the disclosure exemplary methods which are illustrated below with reference to FIGS. 3 and 5.

Schematically, the computer system includes a processing unit 10 with access to four types of database. First, there is a database 20 describing payment transactions made by a plurality of individuals. The database 20 may for example be obtained from a payment network, such as the one operated by MasterCard International Incorporated, and relate to payment transactions made by payment cards.

Secondly, the processing unit 10 has access to a database 30 which contains, in respect of at least some of the population of individuals, contains demographic data and/or location data. The demographic data may include any one of more of: gender, age, and/or marital status. The location data may for example be zipcode (postcode) for the corresponding individuals.

Thirdly, the processing unit 10 has access to a database 40 containing advertising information describing messages which a charity wishes to transmit to appropriate individuals of the population, as part of an advertising campaign.

Fourthly, the processing unit 10 has access to a database 50 of contact information for the individuals, such as a corresponding email address, postal address or telephone number for each of the individuals.

FIG. 2 is a block diagram showing a technical architecture of the computer system 1.

The technical architecture 220 includes a processor 222 (which may be referred to as a central processor unit or CPU, and which plays the role of the processing unit 10 in the schematic description given above). The processor 222 in communication with memory devices including secondary storage 224 (such as disk drives), read only memory (ROM) 226, and random access memory (RAM) 228. The databases 20, 30, 40 and 50 may be stored on any one or more of these memory devices.

The processor 222 may be implemented as one or more CPU chips. The technical architecture 220 may further include input/output (I/O) devices 230, and network connectivity devices 232.

The secondary storage 224 typically includes one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution. In this embodiment, the secondary storage 224 has a mobile wallet registration component 224a, and a mobile wallet payment authorization component 224b including non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture 220 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may include providing computing services via a network connection using dynamically scalable computing resources. A cloud computing environment may be established by an enterprise and/or may be hired on an as-needed basis from a third party provider.

It is understood that by programming and/or loading executable instructions onto the technical architecture 220, at least one of the CPU 222, the RAM 228, and the ROM 226 are changed, transforming the technical architecture 220 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

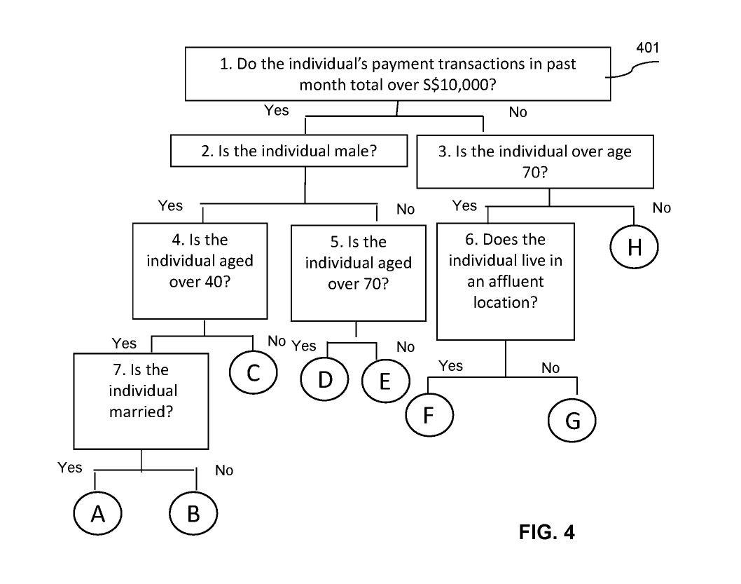

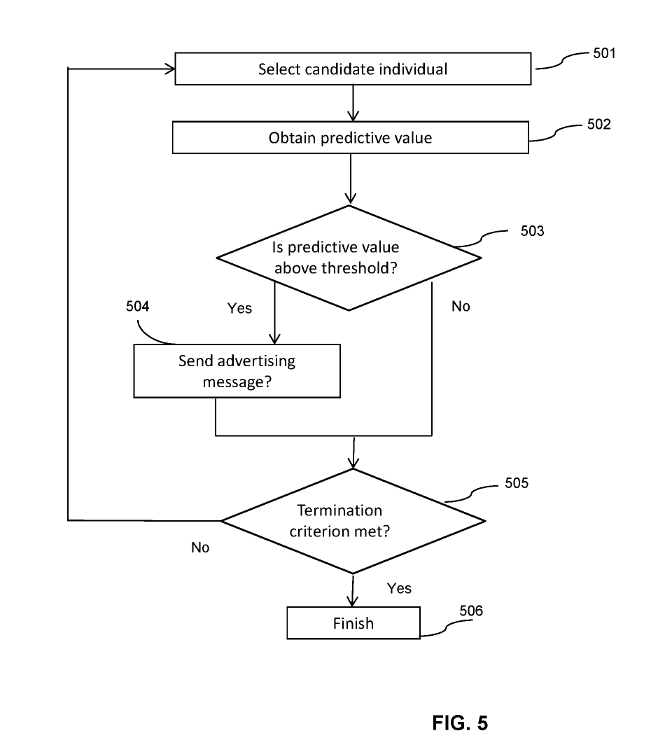

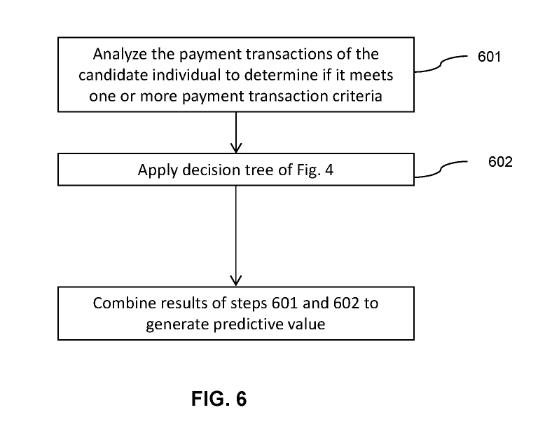

Various operations of the methods carried out by the computer system 10 will now be described with reference to FIGS. 3, 4 and 5. FIG. 3 illustrates the generation of a predictive model for predicting whether a candidate individual of the population can be persuaded to make a donation to a charitable organization, and FIG. 4 illustrates such a model schematically. FIG. 5 illustrates a method of using the model to select candidate individuals to whom to send advertising messages relating to a charitable organization, and for transmitting these messages.

In a first step 301 of the method of FIG. 3, the processing unit 10 receives the transaction data from the database 20. In step 302, the processing unit 10 receives the demographic and/or location data in the database 30.

In step 303, the processing unit 10 identifies a subset of the total population of individuals (the “training subset”) for whom reliable data exists in both the databases 10, 20. For example, the processing unit 10 may check that for a given individual the database 20 contains records of a sufficiently large number of payment transactions to be statistically typical of the individual's total payment behavior (for example, the number of payment transactions (e.g. within a predefined time window) is above a predefined threshold).

In step 304, the processing unit 10 searches the transaction data to identify individuals who have made a payment to any of a predefined set of charitable organization (which may for example by all the charitable organizations operating in the jurisdiction in which the population of individuals live). Thus, it forms a number of records corresponding to the respective training subset of individuals. Each record includes a respective flag value indicating whether the respective individual has made a payment to one of the set of charitable organizations, and a respective set of descriptor values based on the data from the databases 20 and/or 30 describing the respective individual. Thus, the descriptor values may describe the previous payment transactions of the individual (for example, the number of previous payment transactions (e.g. during a certain time window), the total value of those transactions, the median value of the transactions, etc.) and/or one or more demographic characteristic(s) of the individual and/or a geographical location associated with the individual (e.g. his or her billing address). The geographical location may for example be expressed as a zipcode, or converted into another format, such as a variable indicating that the zipcode represents a location with certain pre-defined characteristics (e.g. it is a location in the city or in countryside, or it is a region statistically associated with a certain wealth level, e.g. a place where affluent individuals tend to live).

In step 305, the processing unit 10 generates a predictive model using the records about the training subset of individuals as training data. The predictive model attempts to predict the flag value from the descriptor values. The predictive model is typically an adaptive model, and typically generated iteratively. Conveniently, the predictive model may be a decision tree, of the kind shown in FIG. 4. A predictive value for the flag value for a given individual is reached by moving from the topmost box 401, and asking up to questions about the descriptor values corresponding to the individual. A given set of answers causes the model to reach one of the eight locations in the decision tree marked A to H. Each of the locations A to H corresponds to a set of answers to the questions in the decision tree, and is associated with a respective numerical likelihood for the flag value of the candidate individual indicating that the individual was found to have made a charitable donation. The numerical likelihood may be expressed as a percentage, a value in the range 0 to 1, or in any other way.

For example, in the case of an individual whose payment transactions in the past month total $12,500, who is female and aged 65, the decision tree reaches position E, which is associated with a certain predictive value (e.g. 65%) that the individual has made a charitable donation. The predictive value has been found by observing that 65% of the training subset of individuals for whom the questions had the same answers to the demographic/location questions (i.e. 65% of the individuals in the training subset who were women below the age of 70 who had payment transactions totalling over S$10,000 in the past month) had made a charitable donation according to the database 10. Conversely in the case of an individual whose payment transactions totalled S$9,500, is aged 75 and has a zipcode in an area which has previously been registered as being in the affluent, the path through the decision tree reaches position F, which is associated with a different predictive value, such as 80%. An individual for whom the path reaches the position F is thus more likely to engage in charitable giving than an individual for whom the path reaches position E.

The decision tree of FIG. 4 is made up of seven questions, each of which is referred to as a “split note”. The questions are chosen to give a high degree of discrimination, i.e. such that the values associated with the locations A-H are as close as possible to 0% or 100%, indicating that the answers to the questions are highly correlated with the flag value. The decision tree of FIG. 4 is a binary decision tree in which each question has only two possible answers, but other decision trees can be used in which a split node can be associated with more than two answers. For example, questions 4 and 5 can be equivalently asked as a single question of which of three age ranges (0-40, 41-70, or over 70) the age of the individual falls into. Thus, in the case of a decision tree in which a split node may have up to three answers, the two questions 4 and 5 may be amalgamated into a single question with three answers.

A large number of questions can be used. For example, although question 4 determines whether the individual has an age above a threshold value of 40, any other age may be used as the threshold value. The questions used in the decision tree are chosen to give maximum discrimination (i.e. predictive value) for the flag value. The number of questions may be higher or lower than the 7 shown in FIG. 4. Optionally, they may not include questions about the individual's payment transaction history.

A number of automatic algorithms exist for constructing a decision tree. Many such algorithms are iterative. Some such algorithms are described in Rokach, Lior; Maimon, O. (2008) “Data mining with decision trees: theory and applications”, World Scientific Pub Co Inc. (see also Chapter 1 Barry de Ville and Padriac Neville (2013) “Decision Trees for Analytics Using SAS Enterprise Miner”, SAS Institute Inc.). The most commonly used algorithm is called “top-down induction of decision trees” (TDIDT).

FIG. 5 depicts how the decision tree resulting from the method of FIG. 3 can be used by the computer system 1. In step 501, the processing unit 10 selects an individual (a “candidate individual”) for whom data exists in the database 20 (and also in the database 10 if the decision tree includes questions about payment transaction history of the candidate individual). In step 502, the computer system 10 uses the decision tree of FIG. 4 to obtain a predictive value. This is done by answering the questions of the decision tree using the payment transaction/demographic/location data, to reach one of locations A to H in the position tree, and then finds the numerical predictive value associated with that location. In step 503, the predictive value is compared to a threshold. If it is found that the predictive value is above the threshold, then in step 504 computer system 10 extracts advertising data from the database 30 relating to a campaign from a charitable organization, and sends a message containing the advertising data to the candidate individual using corresponding contact data extracted from the database 40.

In step 505, a determination is made of whether a termination criterion has been met. For example, the termination criterion may be whether steps 501-504 have been carried out for all candidate individuals for whom data exists in databases 30 and 50. Alternatively, if a charitable organization is limited in the number of advertising messages which can be sent, the termination criterion may be whether this number of advertising messages has been sent. If step 505 determines that the termination criterion is met, the method terminates. Otherwise, the method returns to step 501 in which a new candidate individual is selected (one for whom the method of FIG. 5 has not previously been performed).

Many variations of the present scheme are possible. For example, a noted above certain individuals are more likely to contribute to a certain class of charity (e.g. an animal charity). Thus, when the advertising campaign for which data is stored in the database 40 is for a charity in a certain class (e.g. an animal charity), the determination made in step 304 may relate only to charities of the same class (i.e. step 304 determines whether the individual has previously made a donation to an animal charity). The class of charity may be defined by one or more charitable criteria, e.g. one of the charitable criteria may be whether the beneficiaries of the charity are animal or human, another of the charitable criteria may be whether object of the charity is to improve the health of the beneficiaries, yet another may be the type of images the charitable organization uses in advertising messages, e.g. shocking images or positive ones.

Furthermore, the predictive value for a given candidate individual obtained at step 502 may take further information into account than the result of the decision tree of FIG. 4. For example, step 502 may be carried out using the set of steps shown in FIG. 6.

In this case, the processing unit 10 first determines in step 601 whether payment transaction history of the candidate individual meets one or more payment transaction criteria, e.g. ones which are not used in the decision tree. For example, one of the criteria may be whether the candidate individual has made a donation to any charity, or to a charity in the same class as the charity which the method of FIG. 5 will be advertising. Another of the criteria may be the number of payment transactions the candidate individual has made within a predetermined time window. Another may be the total value of the payment transactions within the time window. Another may be the number of days which has passed since the last payment transaction for the candidate individual. All these criteria are broadly indicative of the affluence level of the candidate individual. According to how many of the payment transaction criteria are met, the processing unit 10 may generate a payment transaction metric value.

In step 602 the decision tree is followed to obtain a predictive value for the candidate.

In step 603, the predictive value obtained using the decision tree is modified based on the payment transaction metric value obtained in step 601. For example, let us consider the case that there is only one payment transaction criterion, which is whether the candidate individual has previously made a donation of the specified type. If step 601 concluded that the candidate individual has done this, then the predictive value obtained in step 603 may be modified by making it closer to 100%, e.g. by increasing it such that the difference between it and 100% is halved. Conversely, if step 601 concluded that the candidate individual has not previously made a donation of the specified type, then the predictive value obtained in step 602 may be reduced, e.g. by dividing it by two.

Whilst the foregoing description has described exemplary embodiments, it will be understood by those skilled in the art that many variations of the embodiment can be made within the scope and spirit of the present disclosure.

In the claims:

1. A computer-implemented method for selecting individuals from a population of individuals, the selected individuals being individuals to whom advertising material relating to a charitable organization is to be sent, the method comprising:
(i) analyzing a payment transaction database of payment transactions made by a training set of individuals in the population, to identify those of the training set of individuals for whom the payment transaction database indicates that the corresponding individual has previously made a payment transaction to any of a set of charitable organizations;
(ii) using at least a second database comprising at least one of demographic and location data for the population of individuals, to generate corresponding descriptor values for the training set of individuals;
(iii) generating a predictive model for predicting from the descriptor values for the training set of individuals whether each individual has made a payment to any of the set of charitable organizations;
(iv) for each of a plurality of candidate individuals in the population, using the predictive model and at least data from the second database describing the candidate individual, to generate a respective predictive value indicative of the likelihood of the candidate individual making a donation to a charity; and
(v) based on the predictive values selecting a subset of the candidate individuals to receive the advertising material.

2. A method according to claim 1, wherein the predictive model is generated iteratively.

3. A method according to claim 1, wherein the predictive model is a decision tree.

4. A method according to claim 1, wherein the numerical prediction is generated further employing information from the payment transaction database indicating if the payment transactions for the candidate individual meet one or more payment transaction criteria.

5. A method according to claim 5, wherein the one or more payment transaction criteria include a criterion of whether the candidate individual has previously made a payment to a charitable organization.

6. A method according to claim 1, wherein charitable organization meets one or more charitable criteria, the set of charitable organizations being made up of charitable organizations which also meet the one or more charitable criteria.

7. A computer-implemented method for sending advertising material relating to a charitable organization to selected ones of a population of individuals, the method comprising:
selecting a subset of the individuals using a method according to any preceding claim; and
sending the advertising material to the selected individuals.

8. A computer-system for selecting individuals from a population of individuals, the selected individuals being individuals to whom advertising material relating to a charitable organization is to be sent, the computer system comprising:
(i) a payment transaction database of payment transactions made by the population of individuals;
(ii) a second database comprising at least one of demographic and location data for the population of individuals; and
(iii) a processing unit arranged to:
(a) analyze data in the payment transaction database to identify those of the training set of individuals for whom the payment transaction database indicates that the corresponding individual has made a payment transaction to any of a set of charitable organizations;
(b) use at least the second database to generate corresponding descriptor values for the training set of individuals;
(c) generate a predictive model for predicting from the descriptor values for the training set of individuals whether each individual has made a payment to any of the set of charitable organizations;
(d) for each of a plurality of candidate individuals in the population, use the predictive model and at least data from the second database describing the candidate individual, to generate a predictive value indicative of the likelihood of the candidate individual making a donation to a charity; and
(e) based on the predictive values, select a subset of the candidate individuals to receive the advertising material.

9. A computer system according to claim 8, wherein the processing unit is adapted to generate the predictive model iteratively.

10. A computer system according to claim 8, wherein the processing unit is adapted to generate the predictive model as a decision tree.

11. A computer system according to claim 8, wherein the processing unit is adapted to generate the predictive model further employing information from the payment transaction database indicating if the payment transactions for the candidate individual meet one or more payment transaction criteria.

12. A computer system according to claim 11, wherein the one or more payment transaction criteria include a criterion of whether the candidate individual has previously made a payment to a charitable organization.

13. A computer system according to claim 8 further comprising:
a contact data database containing contact data of individuals in the population; and
the processing unit being adapted to transmit messages comprising the advertising material to the selected candidate individuals using respective contact data for the selected candidate individuals extracted from the contact data database.
